(19) United States
(12) Patent Application Publication
(10) Pub. No.: US 2014/0007905 A1
(43) Pub. Date: Jan. 9, 2014

(54) WAFER CLEANING SYSTEM AND METHOD USING ELECTROLYTIC GAS FOR BACK-END PURGE

(71) Applicants: Chung-Ren SUN, Kaohsiung City (TW); Hsiang Hsiang KO, Sinying City (TW); Miao-Cheng LIAO, Yunlin (TW); Wei-Yang TSENG, Kaohsiung City (TW)

(72) Inventors: Chung-Ren SUN, Kaohsiung City (TW); Hsiang Hsiang KO, Sinying City (TW); Miao-Cheng LIAO, Yunlin (TW); Wei-Yang TSENG, Kaohsiung City (TW)

(73) Assignee: TAIWAN SEMICONDUCTOR MANUFACTURING COMPANY, LTD., Hsinchu (TW)

(21) Appl. No.: 13/544,637

(22) Filed: Jul. 9, 2012

(51) Int. Cl. B08B 3/00

(52) U.S. Cl. 134/6; 134/95.1; 134/30

(57) ABSTRACT

A wafer cleaning system includes a platform, a plurality of wafer holding units over the platform, a front-end rinse nozzle, and a back-end purge unit. The plurality of wafer holding units is set to define a reference plane of wafer holding. The front-end rinse nozzle is above the reference plane and configured to dispense a first rinse fluid toward the reference plane. The back-end purge unit is below the reference plane and configured to dispense an electrolytic gas

### BACKGROUND

To manufacture an integrated circuit (IC), a wafer on which the IC is formed undergoes a variety of processes, such as deposition, etching, and/or polishing, that leave contaminants or particles on a surface of the wafer. These contaminants or particles usually interfere with a subsequent manufacturing process, and thus the surface of the wafer is cleaned (also known as “surface preparation”) in order to remove the contaminants or particles and prepare the wafer for the subsequent manufacturing process.

### DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a perspective view of a wafer cleaning system in accordance with one or more embodiments;

FIG. 2 is a cross-sectional view of the wafer cleaning system taken along a reference plane A depicted in FIG. 1 in accordance with one or more embodiments;

FIG. 3 is an enlarged view of a region B indicated in FIG. 2 in accordance with one or more embodiments;

FIG. 4 is a system block diagram of a wafer cleaning system in accordance with one or more embodiments; and

FIG. 5 is a flowchart of a method of cleaning a wafer in accordance with one or more embodiments.

### DETAILED DESCRIPTION

It is understood that the following disclosure provides one or more different embodiments, or examples, for implementing different features of the disclosure. Specific examples of components and arrangements are described below to simplify the present disclosure. These are, of course, examples and are not intended to be limiting. In accordance with the standard practice in the industry, various features in the drawings are not drawn to scale and are used for illustration purposes only.

Moreover, spatially relative terms, for example, “lower,” “upper,” “horizontal,” “vertical,” “above,” “below,” “up,” “down,” “top,” “bottom,” “left,” “right,” etc. as well as derivatives thereof (e.g., “horizontally,” “downwardly,” “upwardly,” etc.) are used for ease of the present disclosure of one features relationship to another feature. The spatially relative terms are intended to cover different orientations of the device including the features.

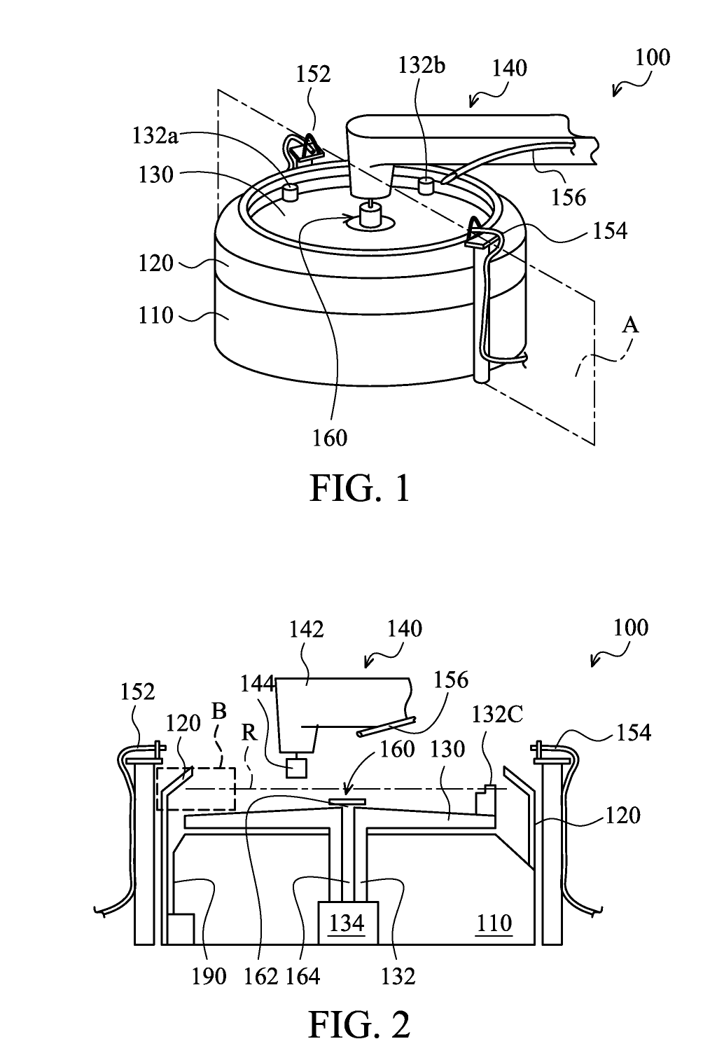

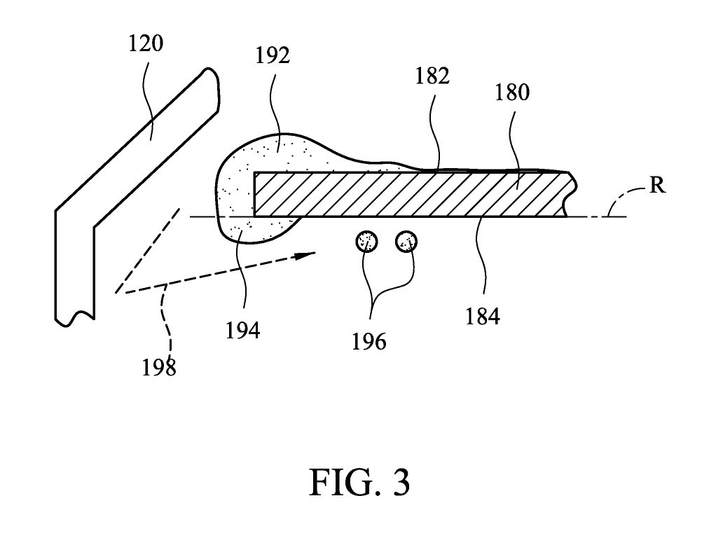

FIG. 1 is a perspective view of a wafer cleaning system 100 in accordance with one or more embodiments. The wafer cleaning system 100 has a base 110, a cover 120 over the base, a platform 130 over the base, a plurality of wafer holding units 132a, 132b, and 132c (FIG. 2) over the platform, and a brush unit 140 over the platform. The wafer cleaning system 100 also has one or more front-end rinse nozzles 152, 154, and 156 and a back-end purge unit 160. The wafer cleaning system 100 is capable of retaining a wafer 180 (FIG. 3) for cleaning an upward-facing surface of the wafer 180 (i.e., the front-end surface with respect to the wafer cleaning system). The one or more front-end rinse nozzles 152, 154, and 156 are used to dispense a rinse fluid toward the wafer 180. The back-end purge unit 160 is used to dispense an electrolytic gas. In some embodiments, a front surface of the wafer 180 having electrical components formed there on is positioned to be the upward-facing surface, and thus is referred to as the front-end surface. In some embodiments, a back surface of the wafer 180 opposite the front surface of the wafer is positioned to be the upward-facing surface, and thus is referred to as the front-end surface.

FIG. 2 is a cross-sectional view of the wafer cleaning system 100 taken along a reference plane A depicted in FIG. 1 in accordance with one or more embodiments. The wafer cleaning system 100 further includes a shaft 132, a motor 134, and a drainage unit 190. The platform 130 is mechanically coupled to the motor 134 via the shaft 132. The motor 134 drives the platform 130 to spin the wafer 180 mounted thereon, and thus the platform is a rotary platform. The drainage unit 190 collects and draws off excessive rinse fluid during operation of the wafer cleaning system 100. Other details of the wafer cleaning system 100 are omitted to facilitate the explanation of the present application.

The plurality of wafer holding units 132a, 132b, and 132c are mounted on the platform 130 and are set to define a reference plane R of wafer holding. The wafer 180, subjected to a cleaning process performed by operating the wafer cleaning system 100, is detachably mounted to the platform 130 by the plurality of wafer holding units 132a, 132b, and 132c and positioned along the reference plane R. The one or more front-end rinse nozzles 152, 154, and 156 are above the reference plane R and used to dispense the rinse fluid toward the reference plane. The back-end purge unit 160 is below the reference plane R and used to dispense the electrolytic gas.

The brush unit 140 is positioned above the reference plane R and includes a robot arm 142 and a brush 144. In some embodiments, the brush 144 rubs the front-end surface of the wafer 180 during the period that the rinse fluid is being dispensed by one or more of the front-end rinse nozzles 152, 154, and 156. In some embodiments, the robot arm 142 is driven to move the brush 144 along the front-end surface of the wafer 180 to clean the front-end surface of the wafer 180. In at least one embodiment, the robot arm 142 is driven to move the brush 144 away from the front-end surface of the wafer 180, and thus the brush is not in contact with the front-end surface of the wafer during the wafer cleaning process. In some example wafer cleaning system, the brush 144 and/or the robot arm 142 are omitted.

The one or more front-end rinse nozzles 152, 154, and 156 depicted in FIG. 1 and FIG. 2 includes two side rinse nozzles (the front-end rinse nozzles 152 and 154) mounted at a periphery of the base 110 of the wafer cleaning system 100 and one brush rinse nozzle (the front-end rinse nozzle 156) mounted on the robot arm 142. In some embodiments, the side rinse nozzles 152 and 154 dispense a first rinse fluid toward the reference plane R, and the brush rinse nozzle 156 dispenses a second rinse fluid toward an area where the brush 144 intersects with the reference plane R. In some embodiments when the brush 144 is driven to rub the front-end surface of the wafer 180, all front-end rinse nozzles 152, 154, and 156 are used to dispense rinse fluid. In some embodiments when the brush 144 is driven to avoid contact with the front-end surface of the wafer 180, the brush rinse nozzle 156 is not used to dispense rinse fluid. In some embodiments, the constituents of the first rinse fluid are different from the constituents of the second rinse fluid. In at least one embodiment, the first rinse fluid and the second rinse fluid include de-ionized water (DIW).

The back-end purge unit 160 includes a dispensing portion 162 and a conduit 164. The dispensing portion 162 is mounted on and protrudes from the platform 130. The conduit 164 is integrally formed with the shaft 132. In some embodiments, the conduit 164 is not integrally formed with the shaft 132 and is instead mounted on the shaft. The back-end purge unit 160 dispenses an electrolytic gas to a back-end surface (identified with respect to the wafer cleaning system 100) of the wafer 180. In some embodiments, the electrolytic gas is chemically inactive with respect to the wafer 180. In other words, the electrolytic gas or a solution of the electrolytic gas does not further chemically react with the wafer 180 to an extent that would render the electrical components or features formed thereon defective. In some embodiments, the electrolytic gas includes carbon dioxide having a volume percentage ranging from 50% to 100%.

FIG. 3 is an enlarged view of a region B indicated in FIG. 2 in accordance with one or more embodiments. In addition, a portion of the wafer 180 positioned along the reference plane R is also depicted in FIG. 3. While cleaning the wafer 180 by operating the wafer cleaning system 100, the motor 134 is driven to spin the wafer 180, and the rinse fluid 192 travels toward a periphery region of the wafer 180 because of centrifugal forces caused by the spinning of the wafer 180. A portion of the rinse fluid 192 (i.e., the rinse fluid 194) further travels from the front-end surface 182 of the wafer 180 to the back-end surface 184 of the wafer 180 due to different air pressure at the boundary layers near the front-end surface 182 and the back-end surface 184 of the wafer 180 and the adhesive force between the rinse fluid 194 and the wafer 180. Another portion of the rinse fluid 192 (i.e., the rinse fluid 196) is tossed away from the front-end surface 182 of the wafer 180 toward an inner wall of the cover 120 and then bounced back to the back-end surface 184 of the wafer 180, as indicated by a moving path depicted by the dotted line 198.

The electrolytic gas dispensed below the reference plane R forms a gas film on the back-end surface 184 of the wafer 180 and is driven toward the peripheral region of the wafer 180 at the same time. Therefore, the electrolytic gas pushes the rinse fluid 194 and 196 away from the wafer and prevents further accumulation of the rinse fluid 194 and 196 at the back-end surface 184 of the wafer 180. In some embodiments where carbon dioxide is used as the electrolytic gas, carbon dioxide molecules are attracted to and trapped in porous structures of a low dielectric constant (low-k) dielectric layer of the wafer 180, and thus further prevent contaminants or particles from being accumulated or trapped in the porous structures of the low-k dielectric layer. Also, carbon dioxide gas further weakens the surface adhesive force between the rinse fluid and the back-end surface 184 of the wafer 180. Thus, compared with a configuration without dispensing the electrolytic gas by the back-end purge unit 160, the rinse fluid 194 and 196 are less likely to adhere to the back-end surface 184 of the wafer 180.

Furthermore, the spinning of the wafer 180 in the wafer cleaning system 100 generates electrostatic charge due to the friction between the wafer 180 and the rinse fluid 192/194/196 or air. The electrostatic charge on the wafer 180 causes failure of the electrical components formed on the wafer 180. In some embodiments, a portion of the electrolytic gas is dissolved in the rinse fluid 194 and 196 and generates ions that remove electrostatic charge accumulated on the back-end surface 184 of the wafer 180. In some embodiments, the rinse fluid also includes the electrolytic gas dissolved therein to prevent electrostatic charge accumulated on the front-end surface 182 of the wafer 180.

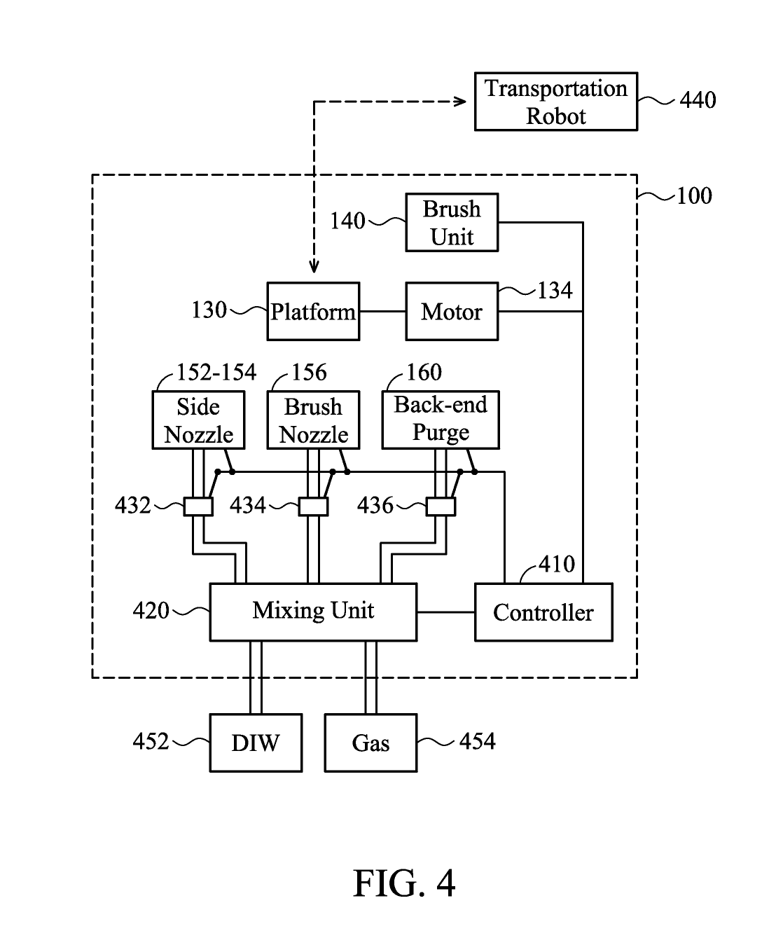

FIG. 4 is a system block diagram of the wafer cleaning system 100 depicted in FIG. 1 in accordance with one or more embodiments. Components that are the same or similar to those depicted in FIG. 1 and FIG. 2 are identified by the same reference numerals.

As depicted in FIG. 4, the wafer cleaning system 100 further has a controller 410, a mixing unit 420, and a plurality of flow meters 432, 434, and 436. In addition, a transportation robot 440 transports a wafer, such as the wafer 180 in FIG. 3, into or out of the wafer cleaning system 100.

The controller 410 is electrically coupled (as indicated by single solid lines) to the brush unit 140, the motor 134, the side rinse nozzles 152/154, the brush rinse nozzle 156, and the back-end purge unit 160 to control the operation of the wafer cleaning system 100. The controller 410 is also electrically coupled to the flow meters 432, 434, and 436 to monitor the amounts of the fluid flows between the mixing unit 420 and the side rinse nozzles 152/154, the brush rinse nozzle 156, and the back-end purge unit 160. In some embodiments, one or more of the flow meters 432, 434, and 436 are omitted. In some embodiments, the controller 410 is positioned outside the wafer cleaning system 100.

The mixing unit 420 is fluid-communicating (as indicated by double solid lines) with a de-ionized water (DIW) source 452 and an electrolytic gas source 454. The mixing unit 420 is also fluid-communicating with the side rinse nozzles 152/154, the brush rinse nozzle 156, and the back-end purge unit 160 via the one or more flow meters 432/434/436. In some embodiments, the mixing unit 420 prepares rinse fluid for the side rinse nozzles 152/154 and the brush rinse nozzle 156 by mixing the received DIW and the received electrolytic gas. In some embodiments, the mixing unit 420 temporarily stores and redirects the received DIW to the side rinse nozzles 152/154 and the brush rinse nozzle 156, and redirects the received electrolytic gas to the back-end purge unit 160. In some embodiments, the DIW source 452 and the electrolytic gas source 454 are positioned outside the wafer cleaning system 100. In some embodiments, the DIW source 452 and the electrolytic gas source 454 include containers positioned inside the wafer cleaning system 100.

In some embodiments, available fluid sources for the producing of rinse fluid and the electrolytic gas include at least one fluid source other than DIW source 452 and the electrolytic gas source 454. In at least one embodiment, the electrolytic gas source 454 is a carbon dioxide source, and the at least one other fluid source includes a nitrogen gas source.

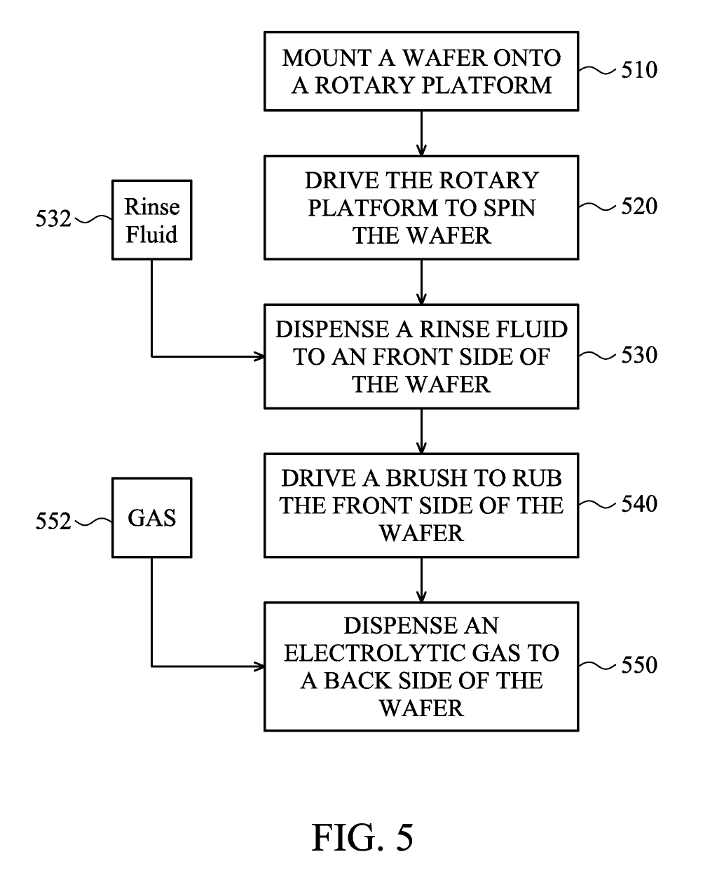

FIG. 5 is a flowchart of a method of cleaning a wafer in accordance with one or more embodiments. It is understood that additional processes may be performed before, during, and/or after the method 500 depicted in FIG. 5, and that some other processes may only be briefly described herein.

As depicted in FIG. 5 and FIG. 4, in operation 510, a wafer 180 is mounted onto a rotary platform 130 by using a plurality of wafer holding units 132a/132b/132c over the rotary platform 130. In operation 520, the rotary platform 130 is driven to spin the wafer 180.

In operation 532, a rinse fluid is prepared. In some embodiments, the rinse fluid is prepared by mixing, in the mixing unit 420, de-ionized water (DIW) and an electrolytic gas that is also used for back-end purge. In some embodiments, the electrolytic gas includes carbon dioxide. In some embodiments, the rinse fluid includes at least constituents other than the DIW and the dissolved electrolytic gas. In at least one embodiment, the rinse fluid contains only the DIW.

In operation 534, the rinse fluid is dispensed to a front-end side 182 of the wafer 180 through one or more front-end rinse nozzles 152, 154, or 156. In operation 540, a brush 144 of a brush unit 140 is driven to rub the front-end side 182 of the wafer 180 during the period that the rinse fluid is being dispensed. In some embodiments, the brush 144 is not used to clean the wafer 180, and thus operation 540 is omitted.

In operation 552, the electrolytic gas received by the mixing unit 420 is redirected to the back-end purge unit 160. In operation 554, the electrolytic gas is dispensed to a back-end side 184 of the wafer 180 through the back-end purge unit 160 during a period that the rinse fluid is being dispensed. In at least one embodiment, the dispensing of the electrolytic gas comprises dispensing a carbon-dioxide containing gas.

In accordance with one embodiment, a wafer cleaning system includes a platform, a plurality of wafer holding units over the platform, a front-end rinse nozzle, and a back-end purge unit. The plurality of wafer holding units is set to define a reference plane of wafer holding. The front-end rinse nozzle is above the reference plane and configured to dispense a first rinse fluid toward the reference plane. The back-end purge unit is below the reference plane and configured to dispense an electrolytic gas.

In accordance with another embodiment, a wafer cleaning system includes a rotary platform, a plurality of wafer holding units over the rotary platform, a front-end rinse nozzle, a back-end purge unit, and a controller. The plurality of wafer holding units is set to define a reference plane of wafer holding. The front-end rinse nozzle is over the reference plane and configured to dispense a rinse fluid toward the reference plane. The back-end purge unit is under the reference plane and configured to dispense an electrolytic gas. The controller is coupled to the front-end rinse nozzle and the back-end purge unit. The controller being is configured to dispense the rinse fluid through the front-end rinse nozzle and to dispense the electrolytic gas through the back-end purge unit during a period the rinse fluid is dispensed.

In accordance with yet another embodiment, a method of cleaning a wafer using a wafer cleaning system includes mounting the wafer onto a rotary platform by using a plurality of wafer holding units over the rotary platform. The rotary platform is driven to spin the wafer. The rinse fluid is dispensed to a front side of the wafer through a front-end rinse nozzle. An electrolytic gas is dispensed to a back side of the wafer through a back-end purge unit during a period that the rinse fluid is being dispensed.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A wafer cleaning system comprising:
a platform;
a plurality of wafer holding units over the platform, the plurality of wafer holding units being set to define a reference plane of wafer holding;
a front-end rinse nozzle above the reference plane, the front-end rinse nozzle being configured to dispense a first rinse fluid toward the reference plane; and
a back-end purge unit below the reference plane, the back-end purge unit being configured to dispense an electrolytic gas.

2. The wafer cleaning system of claim 1, wherein the wafer cleaning system is configured to clean a semiconductor wafer retained by the plurality of wafer holding units, and the electrolytic gas is chemically inactive with respect to the semiconductor wafer.

3. The wafer cleaning system of claim 2, wherein the electrolytic gas comprises carbon dioxide.

4. The wafer cleaning system of claim 1, further comprising a mixing unit configured to:
receive de-ionized water (DIW) and the electrolytic gas;
prepare the first rinse fluid based on at least a portion of the received DIW; and
redirect at least a portion of the received electrolytic gas to the back-end purge unit.

5. The wafer cleaning system of claim 4, further comprising one or more flow meters between the mixing unit and corresponding one or more of the front-end rinse nozzle and the back-end purge unit.

6. The wafer cleaning system of claim 1, further comprising:
a brush unit above the reference plane.

7. The wafer cleaning system of claim 6, wherein the brush unit comprises:
a robot arm; and
a brush rotatably mounted on the robot arm;
wherein the front-end rinse nozzle is mounted on the robot arm and configured to dispense the first rinse fluid toward the reference plane and the brush.

8. The wafer cleaning system of claim 7, further comprising a side rinse nozzle mounted at a periphery of the wafer cleaning system and configured to dispense a second rinse fluid toward the reference plane.

9. The wafer cleaning system of claim 8, further comprising a mixing unit configured to:
receive de-ionized water (DIW) and the electrolytic gas;
prepare the first rinse fluid based on at least a portion of the received DIW;
prepare the second rinse fluid based on at least another portion of the received DIW; and
redirect at least a portion of the received electrolytic gas to the back-end purge unit.

10. The wafer cleaning system of claim 9, further comprising one or more flow meters between the mixing unit and corresponding one or more of the front-end rinse nozzle, the side rinse nozzle, and the back-end purge unit.

11. A wafer cleaning system comprising:
a rotary platform;
a plurality of wafer holding units over the rotary platform, the plurality of wafer holding units being set to define a reference plane of wafer holding;
a front-end rinse nozzle over the reference plane, the front-end rinse nozzle being configured to dispense a rinse fluid toward the reference plane;
a back-end purge unit under the reference plane, the back-end purge unit being configured to dispense an electrolytic gas; and
a controller coupled to the front-end rinse nozzle and the back-end purge unit, the controller being configured to dispense the rinse fluid through the front-end rinse nozzle and to dispense the electrolytic gas through the back-end purge unit during a period the rinse fluid is dispensed.

12. The wafer cleaning system of claim 11, wherein the controller is coupled to the rotary platform and configured to drive the rotary platform to spin during the period the rinse fluid is dispensed.

13. The wafer cleaning system of claim 12, wherein the controller is configured to drive the rotary platform to spin at a rotational speed ranging from 300 to 1000 revolutions per minute (rpm).

14. The wafer cleaning system of claim 11, wherein the wafer cleaning system is configured to clean a semiconductor wafer retained by the plurality of wafer holding units, and the electrolytic gas is chemically inactive with respect to the semiconductor wafer.

15. The wafer cleaning system of claim 14, wherein the electrolytic gas comprises carbon dioxide.

16. The wafer cleaning system of claim 11, wherein the rotary platform comprises a motor and a shaft connected to the motor, and the back-end purge unit comprises a conduit integrated with the shaft.

17. A method of cleaning a wafer using a wafer cleaning system, the method comprising:
mounting the wafer onto a rotary platform by using a plurality of wafer holding units over the rotary platform;
driving the rotary platform to spin the wafer;
dispensing a rinse fluid to an front side of the wafer through a front-end rinse nozzle; and
dispensing an electrolytic gas to a back side of the wafer through a back-end purge unit during a period that the rinse fluid is being dispensed.

18. The method of claim 17, further comprising:
driving a brush to rub the front side of the wafer during the period that the rinse fluid is being dispensed.

19. The method of claim 17, further comprising:
producing the rinse fluid by mixing de-ionized water (DIW) and carbon dioxide.

20. The method of claim 17, wherein the dispensing of the electrolytic gas comprising dispensing a carbon-dioxide containing gas.
